(19) United States
(12) Patent Application Publication
(10) Pub. No.: US 2024/0394168 A1
(43) Pub. Date: Nov. 28, 2024

(54) SIMULATION METHOD

(71) Applicant: HITACHI ASTEMO, LTD., Hitachinaka-shi, Ibaraki (JP)

(72) Inventors: Yuma KATO, Chiyoda-ku, Tokyo (JP); Tasuku ISHIGOOKA, Chiyoda-ku, Tokyo (JP); Yasuhiro FUSE, Chiyoda-ku, Tokyo (JP); Akihiro KONDO, Chiyoda-ku, Tokyo (JP); Yoshitaka ATARASHI, Chiyoda-ku, Tokyo (JP)

(73) Assignee: HITACHI ASTEMO, LTD., Hitachinaka-shi, Ibaraki (JP)

(21) Appl. No.: 18/712,314

(22) PCT Filed: Aug. 15, 2022
(86) PCT No.: PCT/JP2022/030881

§ 371 Date: May 22, 2024

(30) Foreign Application Priority Data
Dec. 13, 2021 (JP) 2021-201687

(51) Int. Cl. G06F 11/34

(52) U.S. Cl. CPC G06F 11/3419; G06F 11/3457

(57) ABSTRACT

To reproduce, in consideration of the distributed hardware configuration, a software execution timing in a target environment on a host environment with high accuracy. A simulation method includes: extracting a first host feature value 11 obtained by executing first software 10 on a host environment 100; executing the first software 10 on a target environment 110 to calculate a target execution time 20 taken to execute the first software 10 on the target environment 110; calculating a performance difference between the host environment 100 and the target environment 110 based on the first host feature value 11 and the target execution time 20; extracting a second host feature value 13 obtained by executing second software 12 on the host environment 100; and estimating a time 40 taken to execute the second software 12 on the target environment 110 based on the second host feature value 13 and the performance difference.

### TECHNICAL FIELD

This invention relates to a simulation method.

### BACKGROUND ART

As an existing technique to approach an execution timing of a PC simulation environment to an actual ECU, there is a technique described in Patent Literature 1. An object of Patent Literature 1 is to provide a simulation device that has a function of adding a delay process for causing the execution timing of the PC simulation environment approach that of the actual ECU. As the solution, the simulation device is disclosed that converts application software into an execution code, verifies the code, and ports the execution code after the validation to another calculator, the simulation device performing a time adjustment process at start or termination of a function in units of functions of a source code of an application, to adjust an execution timing in another calculator.

### CITATION LIST

### Patent Literature

Patent Literature 1: WO 2019/244472

### SUMMARY OF INVENTION

### Technical Problem

According to the method described in Patent Literature 1, by performing the time adjustment process at start or termination of the function in units of the functions of the software, the execution timing can be simulated close to that of the actual ECU. However, in Patent Literature 1, the execution timing is adjusted based on a speed ratio between the simulation device and the calculator (CPU clock ratio), it is not considered that features of programs of a cache, a bus, and the like and features of a microcomputer, affect the execution time. Therefore, it is a problem that with the speed ratio alone, accuracy of the adjustment is insufficient.

In Patent Literature 1, a distributed hardware configuration is not considered. Therefore, there is a problem that latency due to a difference in a communication timing when two functions (pieces of software) are operated on different pieces of hardware cannot be reproduced.

Accordingly, in consideration of the distributed hardware configuration, reproduction of a target (actual ECU) environment with high accuracy on a host (PC simulation) environment is an object.

### Solution to Problem

A simulation method for solving the above problems, includes: extracting a first host feature value obtained by executing first software on a host environment; executing the first software on a target environment to calculate a target execution time taken to execute the first software on the target environment; calculating a performance difference between the host environment and the target environment based on the first host feature value and the target execution time; extracting a second host feature value obtained by executing second software on the host environment; and estimating a time taken to execute the second software on the target environment based on the second host feature value and the performance difference.

### Advantageous Effects of Invention

According to the present invention, in consideration of the distributed hardware configuration, a target environment is reproduced with high accuracy on a host environment developing software. That is, the target environment is simulated on the host environment. Therefore, even when the software is not actually ported to the target environment, whether the software can be normally executed on the target environment can be verified to thereby improve development efficiency of the software.

Further features related to the present invention will be apparent from the description of the present specification and the accompanying drawings. Objects, configurations, and effects other than the above will be apparent from the description of the following embodiments.

### BRIEF DESCRIPTION OF DRAWINGS

FIG. 1 is a diagram illustrating a configuration of a host environment 100.

FIG. 2 is a diagram illustrating a configuration of a target environment 110.

FIG. 3 is a diagram illustrating an outline of an entire process executed using a simulation method in a first embodiment.

FIG. 4 is a diagram illustrating an outline of a process flow executed by a host feature value acquisition unit 1.

FIG. 5 is a diagram illustrating an example of a host feature value 11.

FIG. 6 is a diagram illustrating an outline of a process flow executed by a target execution time acquisition unit 2.

FIG. 7 is a diagram illustrating an example of a target execution time 20.

FIG. 8 is a diagram illustrating an outline of a process flow executed by a software execution management unit 5.

FIG. 9 is a diagram illustrating an outline of an entire process executed using a simulation method in a second embodiment.

FIG. 10 is a diagram illustrating an example of device assignment information 50.

FIG. 11 is a diagram illustrating an example of data flow information 51.

FIG. 12 is a diagram illustrating an example of inter-device adjustment coefficient information 52.

FIG. 13 is a diagram illustrating an outline of a process flow executed by the software execution management unit 5 in the second embodiment.

FIG. 14 is a diagram illustrating an outline of an entire process executed using a simulation method in a third embodiment.

FIG. 15 is a diagram illustrating an example of cycle information 60.

FIG. 16 is a diagram illustrating an outline of a process flow executed by an execution order estimation unit 6.

FIG. 17 is a diagram illustrating an outline of a process flow executed by an execution order validation unit 7.

FIG. 18 is a diagram illustrating an outline of an entire process executed using a simulation method in a fourth embodiment.

FIG. 19 is a diagram illustrating an example of a software specification 80.

FIG. 20 is a diagram illustrating an outline of a process flow executed by a specification evaluation unit 8.

FIG. 21 is a diagram illustrating an outline of a process flow executed by a function assignment unit 9.

### DESCRIPTION OF EMBODIMENTS

This embodiment relates to a simulation method of software. Hereinafter, examples of embodiments preferred to the present invention (embodiments) will be described.

### First Embodiment

### <Configuration of Host Environment>

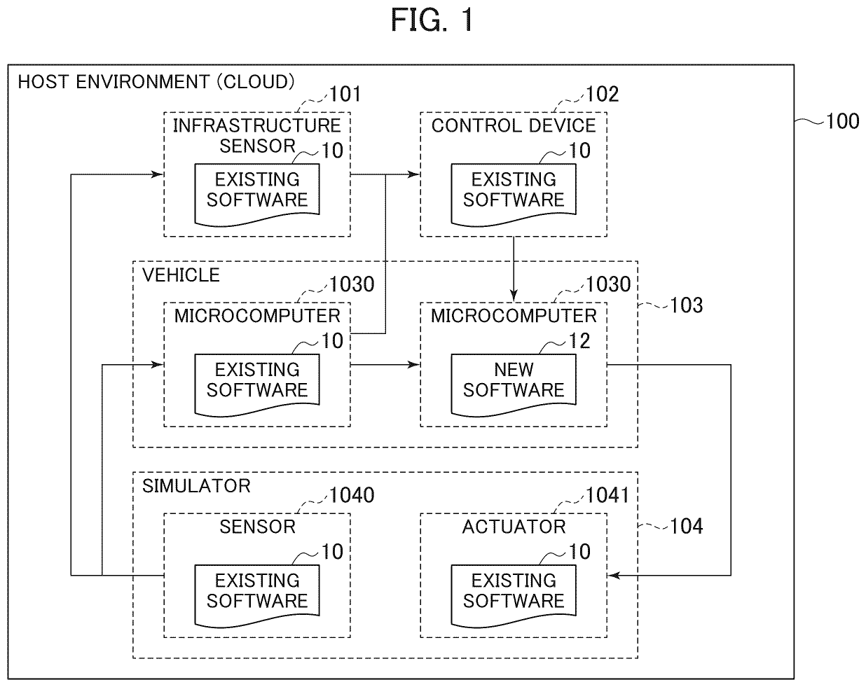

FIG. 1 is a diagram illustrating a configuration of a host environment (cloud) 100 in the present invention.

The host environment 100 in this embodiment aims to develop/verify a software part in a control cooperation automatic driving system. Here, a configuration of hardware in the control cooperation automatic driving system includes an infrastructure sensor 101, a control device 102, and a vehicle 103. The vehicle 103 includes at least one or more microcomputers 1030.

On the host environment 100, existing software 10 and new software 12 are implemented. In an actual environment, they are pieces of software executed on the infrastructure sensor 101, the control device 102, and the vehicle 103. Since the host environment 100 does not include an actual sensor 1040 or an actuator 1041, a simulator 104 includes the existing software 10 that simulates the sensor 1040 and the actuator 1041.

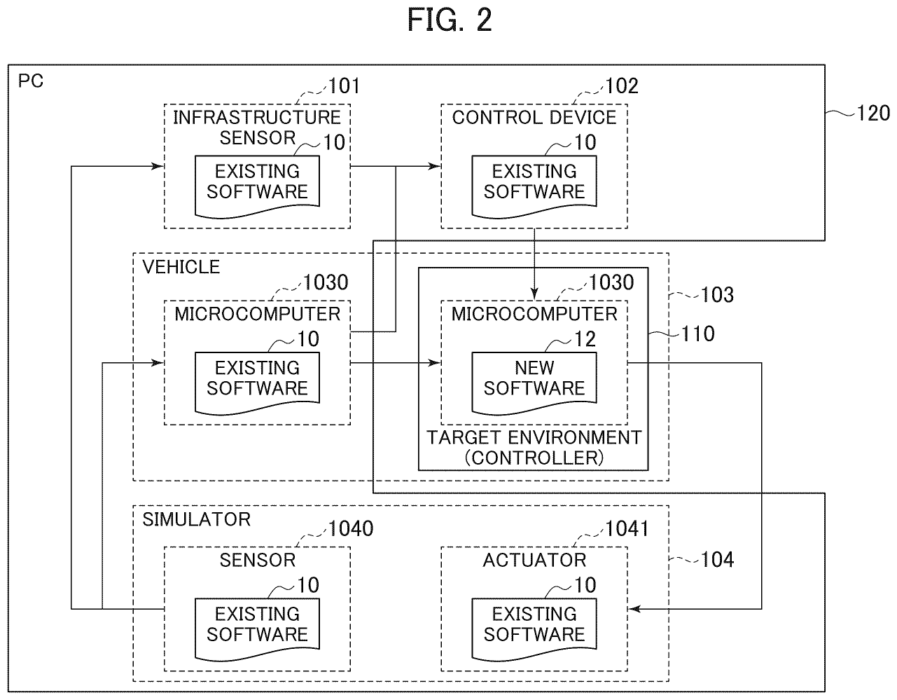

The new software 12 is developed on the host environment 100 and ported to a target environment 110 (see FIG. 2). Each software, for example, provides functions, such as object recognition, route plan, and calculation of a control command value. In FIG. 1, the new software 12 is software implemented to the microcomputer 1030 inside the vehicle 103. However, the new software 12 may be implemented to another device.

### <Configuration of Target Environment>

FIG. 2 is a diagram illustrating a configuration of the target environment (controller) 110 in the present invention.

The target environment 110 has an actual hardware configuration in the control cooperation automatic driving system, and, for example, the target environment 110 in FIG. 2 is the microcomputer 1030 mounted on the vehicle 103.

A peripheral of the target environment 110 (such as a built-in device and a peripheral device) is simulated by a PC 120 as illustrated in FIG. 2, or the infrastructure sensor 101, the control device 102, and the vehicle 103 are actually provided. When the actual hardware configuration is provided, since the sensor 1040 and the actuator 1041 are mounted on the vehicle 103, the simulator 104 is unnecessary. Similarly, since each hardware is present, the PC 120 is also unnecessary. As described above, the new software 12 is developed on the host environment 100, but is ported to the target environment 110.

In FIG. 2, the new software 12 is software implemented to the microcomputer 1030 inside the vehicle 103. However, the new software 12 may be implemented to another device.

### <Outline of Simulation Method>

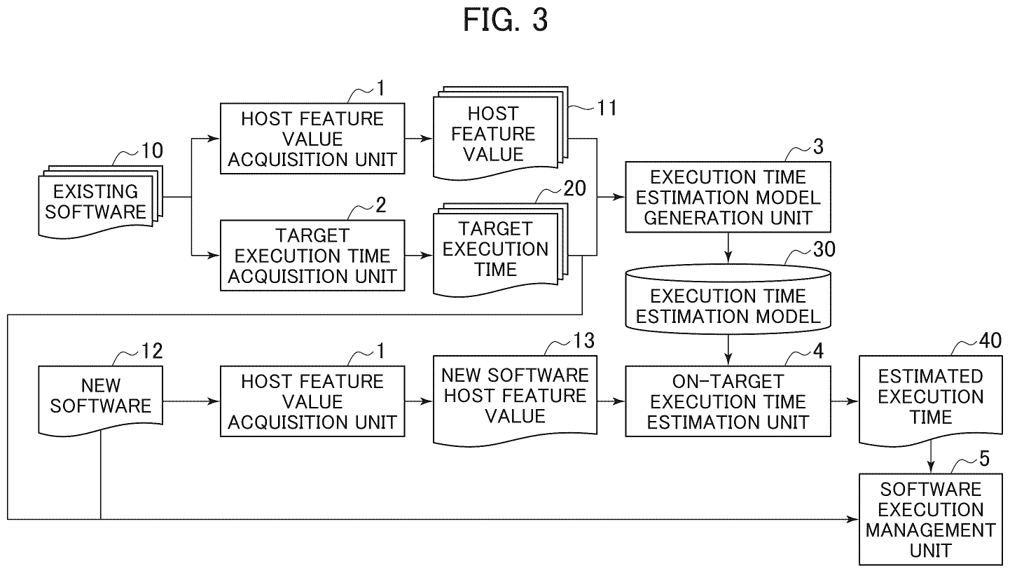

FIG. 3 is a diagram illustrating an outline of the simulation method in the first embodiment.

The simulation method according to the embodiment is executed by a host feature value acquisition unit 1, a target execution time acquisition unit 2, an execution time estimation model generation unit 3, an on-target execution time estimation unit 4, and a software execution management unit 5.

The host feature value acquisition unit 1 is, for example, a functional unit mounted on the host environment 100. When various kinds of software are executed under the host environment, a host feature value 11 described later including information, such as execution time, is calculated and acquired.

The target execution time acquisition unit 2 is, for example, a functional unit mounted on the target environment 110 and acquires a target execution time 20 taken when the existing software 10 is executed on the target environment.

The execution time estimation model generation unit 3 is, for example, a functional unit mounted on the host environment 100 and calculates a performance difference between the host environment 100 and the target environment 110 based on the host feature value 11 and the target execution time 20. Then, an execution time estimation model 30 to estimate the execution time taken when any given software is executed on the target environment 110 is created.

The on-target execution time estimation unit 4 is, for example, a functional unit mounted on the host environment 100, estimates the execution time taken when the new software 12 is executed on the target environment 110 from the execution time estimation model 30 and the new software host feature value 13 obtained when the new software 12 is executed on the host environment, and generates an estimated execution time 40.

The software execution management unit 5 is, for example, a functional unit mounted on the host environment 100 and manages the execution of the software on the host environment 100 based on the estimated execution time 40.

The following describes the above-described respective functional units and various data in detail.

### <Host Feature Value Acquisition Unit>

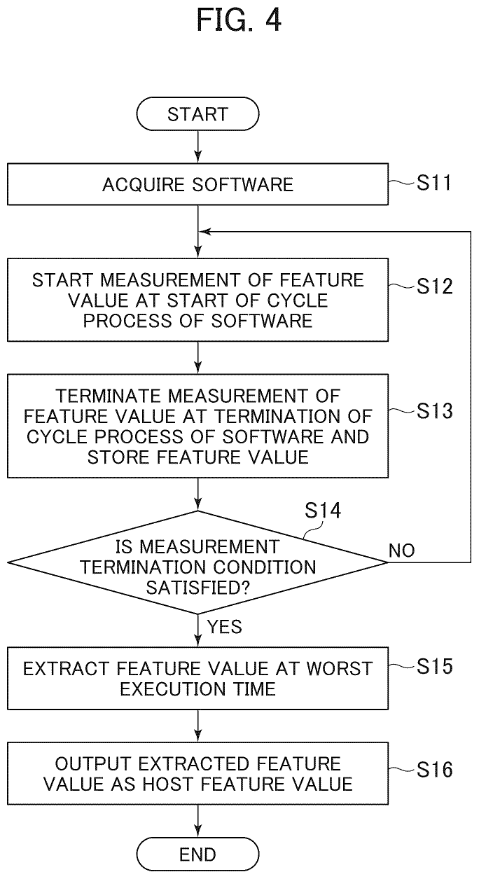

FIG. 4 is a diagram illustrating an outline of a process flow executed by the host feature value acquisition unit 1.

The host feature value acquisition unit 1 acquires software target for measuring the feature value in Step S11. In Step S12, the measurement of the feature value starts at start of a cycle process of the software.

In Step S13, at termination of the cycle process of the software, the measurement of the feature value is terminated and the feature value is stored.

In Step S14, whether an execution result of the software satisfies a measurement termination condition is determined. When the measurement termination condition is satisfied, the process proceeds to Step S15, and when the measurement termination condition is not satisfied, the process returns to Step S12. The measurement termination condition, for example, can be determined from whether any given time has passed, whether a destination has been arrived by automatic driving when the software relates to automatic driving, and whether an error, such as the automatic driving having been not able to be continued, is issued. Additionally, a plurality of the measurement termination conditions may be combined.

In Step S15, among the feature values stored in Step S13, the feature value at the worst execution time is extracted. Here, the worst execution time means the longest time taken for executing a specific calculation task in specific hardware. In this embodiment, it means the longest cycle obtained when the existing software 10 or the new software 12 is periodically executed by the certain number of times or more on the host environment 100. By extracting the feature value at the worst execution time on the host environment 100, when the execution on the target environment 110 is simulated on the host environment 100, it can be expected that the worst execution time on the target environment 110 is reproduced, and accuracy of validation can be maintained.

In Step S16, the feature value extracted in Step S15 is output as the host feature value 11.

In such a procedure, the host feature value acquisition unit 1 acquires the host feature value 11.

### <Host Feature Value>

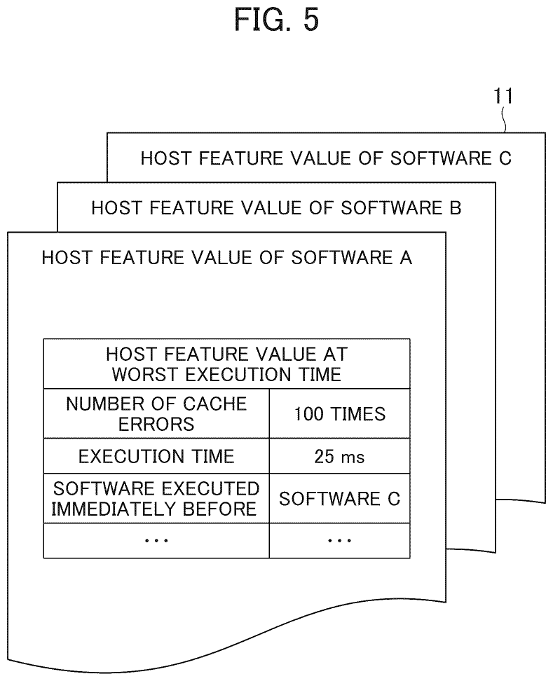

FIG. 5 is a diagram illustrating an example of the above-described host feature value 11.

The host feature value 11 is output as the feature value acquired at each cycle for each software. The kind of the feature value illustrated in FIG. 5 is an example, and the following lists candidates target for the feature value.
Execution time: the time taken for executing the software.
The number of CPU cycles: the number of CPU cycles taken for executing the software and a value found by dividing it by a CPU frequency becomes the execution time.
The number of cache errors: when a cache error occurs, a process that takes time, such as memory access, is required. The cache error includes a Last Level Cache (LLC), L1, and L2.
The number of times of context switch: when the CPU is used in a process different from a process in execution, such as an interrupt process, a process to store/restore the state of the CPU is generated.
The number of CPU migrations: when the process moves to another CPU, a process to transfer the state of the CPU is generated.
The number of retired instructions: although a process was speculatively executed, an instruction was not used and a necessary instruction need to be executed after branch, and therefore, the execution time delays.
The number of branch errors: the number of branches failed to the speculative execution and the necessary instruction need to be executed after the branch, and therefore the execution time delays.
The number of storage forwards: use of data in a buffer, not a cache, when an instruction of executing reading from the same address after an instruction of writing to a certain memory address, and times taken for the access differ between the cache and the buffer.
The number of loading blocks: the number of failures of data loading and the data is attempted to be loaded again as necessary. Therefore, the process increases.
The number of storage blocks: the number of failures of storage of data and the data is attempted to be stored again as necessary. Therefore, the process increases.
The number of out-of-range loads: when access is attempted to an outside a range in which access is possible by software, an error possibly occurs and the access is not normally executed, and therefore the execution time differs from the execution time during normal.
The number of access failures due to imperfect address: due to array of the imperfect address, data is not present in a consecutive address and access to another address is required.
The number of Data-Translation Lookaside Buffer (DTLB) loading errors: the number of times that a requested address is not within the TLB and a page table need to be referred to convert the address and the process increases.
The number of memory disambiguation events: when a loading instruction and a storage instruction in dependence relationship are executed in parallel, the storage instruction need to be executed first, and the loading instruction need to wait for the execution of the storage instruction.
The number of retired memory accesses: the number of memory accesses that are retired due to a change of a memory attempted to be accessed by another core, and an additional process is required for access.
The number of hardware interrupt events: the number of occurrences of the hardware interrupt event, and when the interrupt is generated, processes of store/restore are required.
The number of prefetches: the number of times that the CPU has read data from the memory to a cache memory in advance and times taken for access differ between the memory and the cache.
The number of cache lock cycles: the number of cycles that the cache was locked and it is required to wait until the cache is unlocked.
The number of cycles of execution stop: the number of cycles in which the execution stops and affects the number of cycles of software execution.
Software executed immediately before: depending on a situation of the cache of the software executed most recently, for example, since data desired to be Read is within the cache, it is considered that high-speed Read can be executed.

### <Target Execution Time Acquisition Unit>

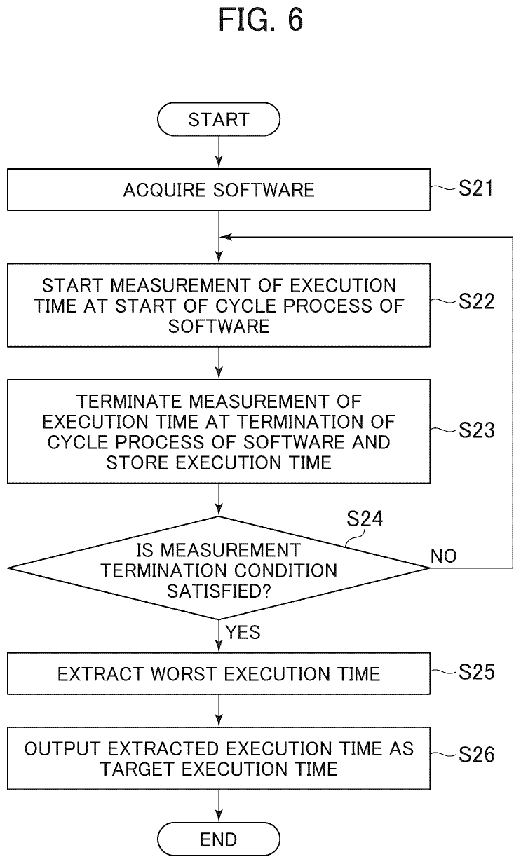

FIG. 6 is a diagram illustrating an outline of a process flow executed by the target execution time acquisition unit 2.

The target execution time acquisition unit 2 acquires software target for measuring the execution time in Step S21.

In Step S22, the measurement of the execution time starts at start of the cycle process of the software.

In Step S23, at termination of the cycle process of software, the measurement of the execution time is terminated and the execution time is stored.

In Step S24, whether an execution result of the software satisfies a measurement termination condition is determined. When the measurement termination condition is satisfied, the process proceeds to Step S25, and when the measurement termination condition is not satisfied, the process returns to Step S22. The measurement termination condition, for example, can be determined from whether any given time has passed, whether a destination has been arrived by automatic driving when the software relates to automatic driving, and whether an error, such as the automatic driving having been not able to be continued, is issued. Additionally, a plurality of the measurement termination conditions may be combined.

In Step S25, among the execution times stored in Step S23, the worst execution time is extracted.

In Step S26, the worst execution time extracted in Step S25 is output as the target execution time 20.

In such a procedure, the target execution time acquisition unit 2 acquires the target execution time 20.

### <Target Execution Time>

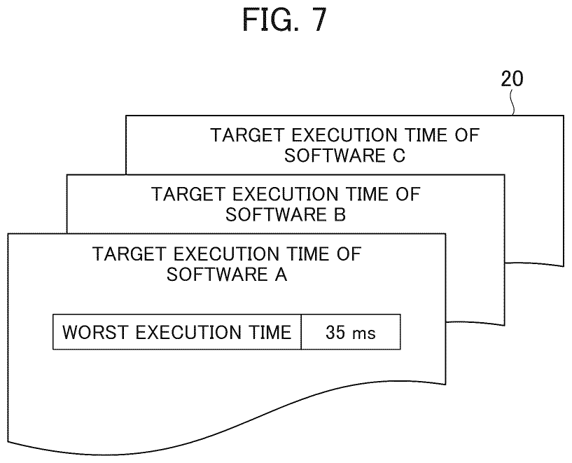

FIG. 7 is a diagram illustrating an example of the target execution time 20 in the present invention. In this embodiment, as the target execution time 20, the worst execution time acquired for each software is stored.

### <Execution Time Estimation Model Generation Unit>

The host feature value 11 and the target execution time 20 obtained in the above-described processes are output to the execution time estimation model generation unit 3. The execution time estimation model generation unit 3 executes machine learning with the host feature value 11 as an independent variable (explanatory variable) and the target execution time 20 as a dependent variable (objective variable) to generate the execution time estimation model 30. As an algorithm of the machine learning, the known algorithm, such as multiple regression analysis and DNN, is used.

### <Execution Time Estimation Model>

The execution time estimation model 30 created by the execution time estimation model generation unit 3 is a model that outputs the estimated execution time 40 when the new software host feature value 13 is input.

### <On-Target Execution Time Estimation Unit>

The on-target execution time estimation unit 4 receives the execution time estimation model 30 output by the execution time estimation model generation unit 3 and the new software host feature value 13 obtained by inputting the new software 12 to the host feature value acquisition unit 1 as inputs. By inputting the new software host feature value 13 to the execution time estimation model 30, the estimated execution time 40 estimated to be taken when the new software 12 is executed on the target environment 110 is obtained.

### <Estimated Execution Time>

The estimated execution time 40 in this embodiment is the predicted worst execution time when the new software 12 is executed on the target environment 110.

### <Software Execution Management Unit>

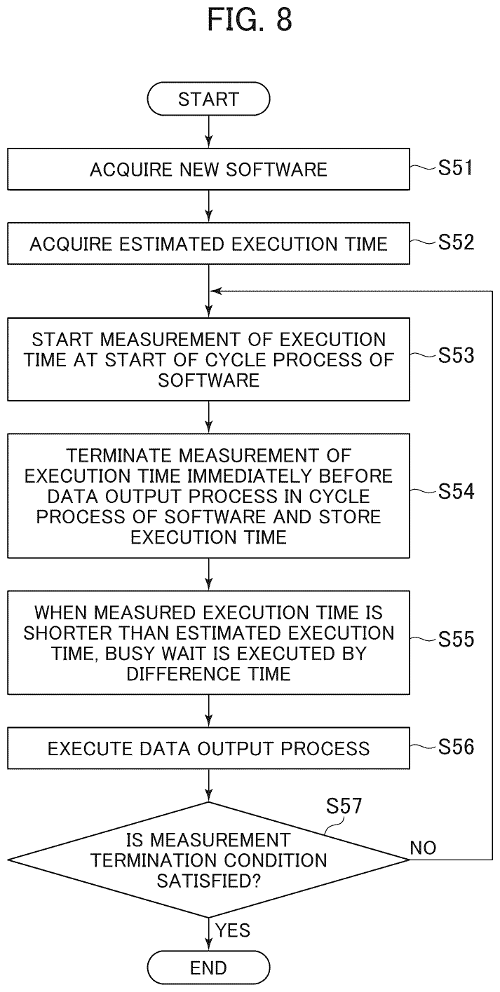

FIG. 8 is a diagram illustrating an outline of a process flow executed by the software execution management unit 5.

The software execution management unit 5 acquires the new software 12 target for simulation in Step S51.

In Step S52, the estimated execution time 40 is acquired from the on-target execution time estimation unit 4.

In Step S53, the measurement of the execution time starts at start of the cycle process of the software.

In Step S54, immediately before a data output process in the cycle process of the software, the measurement of the execution time is terminated and the execution time is stored.

In Step S55, when the measured execution time is shorter than the estimated execution time 40, busy wait is executed by the difference time. That is, the usual host environment 100 has an arithmetic operation ability higher than the target environment 110. Therefore, the execution time of each of the processes when certain software is executed on the host environment 100 is shorter than the estimated time taken for executing the software on the target environment 110. Therefore, by standing by the time of the difference between the estimated execution time of each of the processes when the software is executed on the host environment 100 and the actual execution time, the target environment 110 can be simulated on the host environment with high accuracy.

In Step S56, the output process of the data obtained as the result of execution of the software is executed. In Step S57, whether an execution result of the software satisfies a measurement termination condition is determined. When the measurement termination condition is satisfied, the process is terminated, and when the measurement termination condition is not satisfied, the process returns to Step S53. The measurement termination condition, for example, can be determined from whether any given time has passed, whether a destination has been arrived by automatic driving, and whether an error when the software relates to automatic driving, such as the automatic driving having been not able to be continued, is issued. Additionally, the plurality of measurement termination conditions may be combined.

In such a procedure, the software execution management unit 5 executes the new software 12 on the host environment 100 and simulates the execution of the new software 12 on the target environment 110.

According to the simulation method in the above-described first embodiment, by executing the existing software 10 on the respective host environment 100 and target environment 110 in advance, the execution time estimation model 30 that can estimate the worst execution time on the target environment 110 is generated from the host feature value 11. By inputting the new software host feature value 13 obtained by executing the new software 12 on the host environment 100 to the execution time estimation model 30, without actually porting the new software 12 to the target environment 110, the worst execution time when the new software 12 is executed on the target environment 110 can be estimated. Then, based on the estimated execution time 40, executing the new software 12 on the host environment 100 while the execution time is adjusted allows validation by simulating the execution of the new software 12 on the target environment 110 with high accuracy. Therefore, the new software 12 developed on the host environment 100 can be seamlessly ported to the target environment 110.

### Second Embodiment

Subsequently, a simulation method in the second embodiment of the present invention will be described.

The second embodiment differs from the first embodiment in that, in addition to the information used in the first embodiment, using device assignment information 50, data flow information 51, and inter-device adjustment coefficient information 52, communications between the software are reproduced and an execution timing of the software on the host environment 100 is adjusted. Note that the identical reference numeral is given to the configuration similar to the first embodiment and the description will be omitted.

### <Outline of Simulation Method>

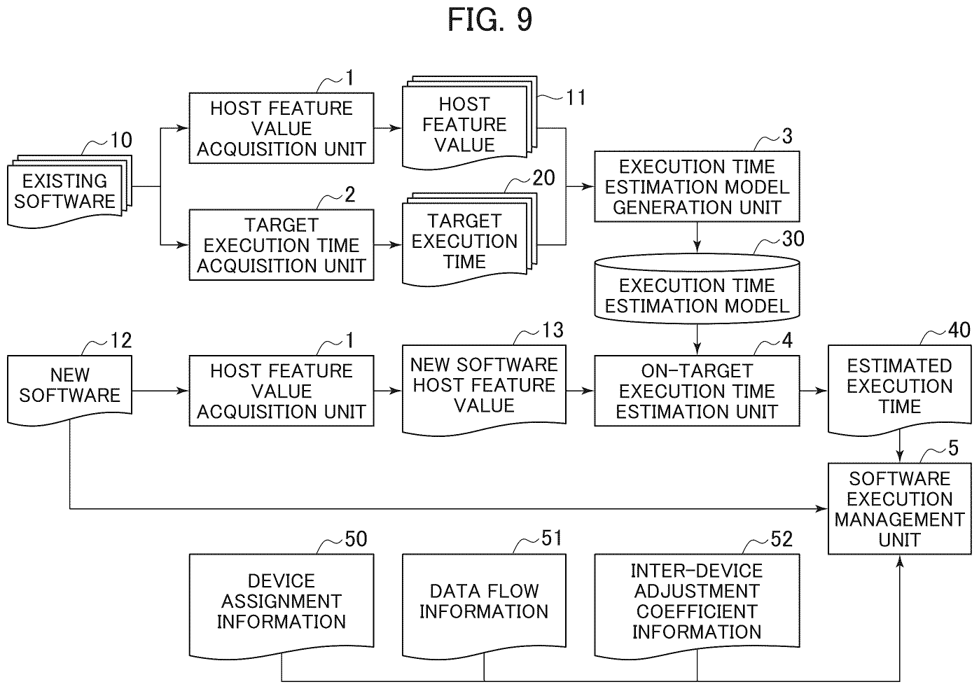

FIG. 9 is a diagram illustrating an outline of the simulation method in the second embodiment.

In this embodiment, in addition to the estimated execution time 40, the device assignment information 50, the data flow information 51, and the inter-device adjustment coefficient information 52 are input to the software execution management unit 5. Note that the device assignment information 50, the data flow information 51, and the inter-device adjustment coefficient information 52 are, for example, stored in the host environment 100.

### <Device Assignment Information>

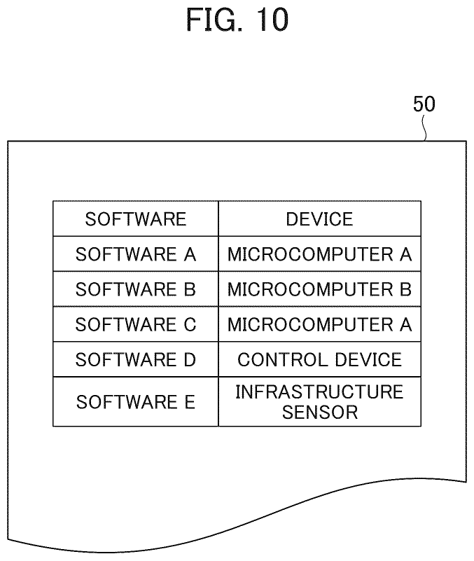

FIG. 10 is a diagram illustrating an example of the device assignment information 50 in the present invention. The device assignment information 50 indicates information that each software operates on which device. In this embodiment, for example, software A and software C operate on a microcomputer A and software B operates on a microcomputer B.

### <Data Flow Information>

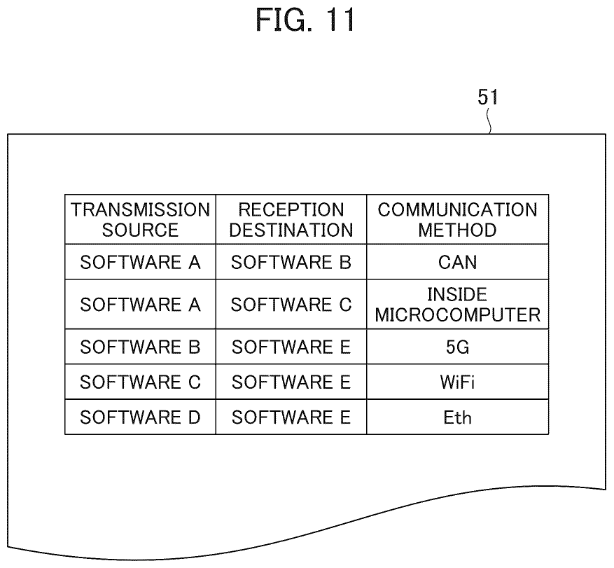

FIG. 11 is a diagram illustrating an example of the data flow information 51 in the present invention.

The data flow information 51 indicates information that each software transmits data to which software and what sort of a communication method. In this embodiment, for example, the software A transmits data to the software B using a Controller Area Network (CAN) and transmits data to the software C inside the microcomputer (for example, intra-process communication).

### <Inter-Device Adjustment Coefficient Information>

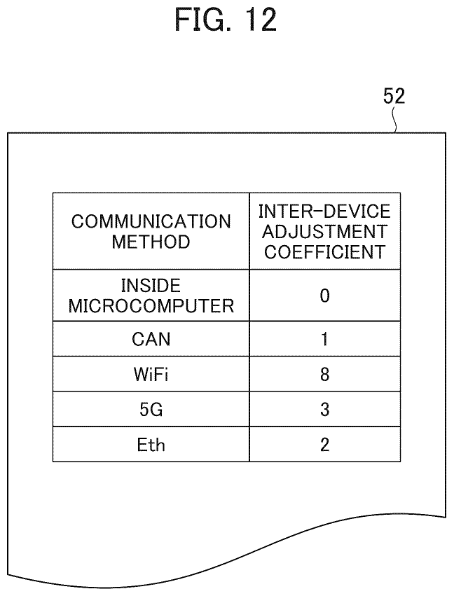

FIG. 12 is a diagram illustrating an example of the inter-device adjustment coefficient information 52 in the present invention.

The inter-device adjustment coefficient information 52 indicates information of an inter-device adjustment coefficient to set how extent a timing of data transmission and reception is adjusted between devices. For example, although the inside of the microcomputer allows high-speed data transmission and reception, the adjustment is unnecessary (the coefficient is 0), in the case of Wi-Fi (registered trademark), since it is wireless, a delay to be adjusted is set to large (the coefficient is 8). The inter-device adjustment coefficient is determined by actually executing the measurement on the target environment 110 or determined from the specification of the target environment 110 and a transmitted data size.

### <Software Execution Management Unit>

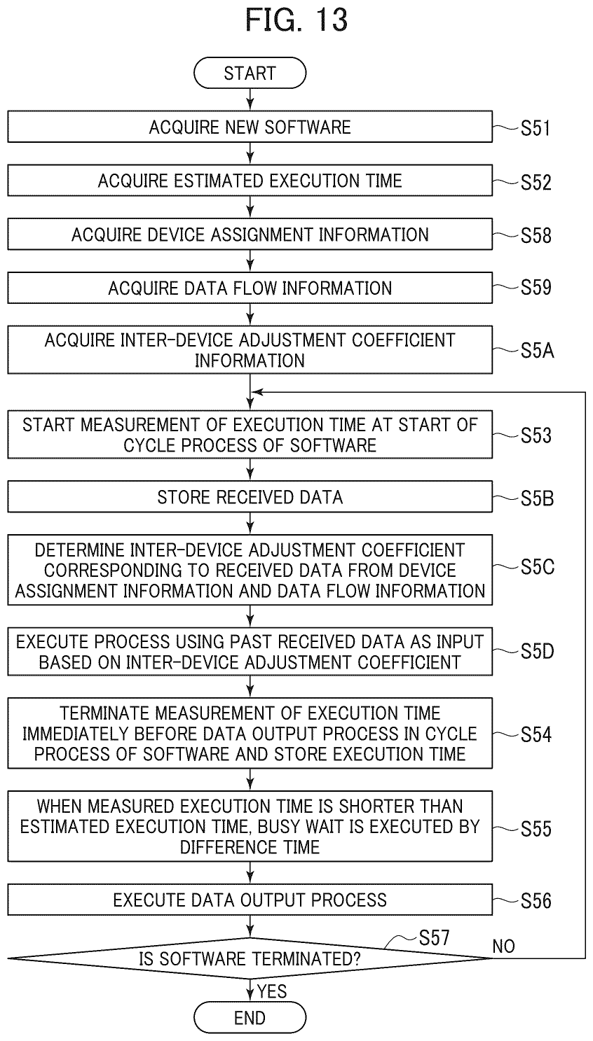

FIG. 13 is a diagram illustrating an outline of a process flow executed by the software execution management unit 5 in the second embodiment.

The software execution management unit 5 acquires the new software 12 target for simulation in Step S51.

In Step S52, the estimated execution time 40 is acquired from the on-target execution time estimation unit 4.

In Step S58, the device assignment information 50 is acquired.

In Step S59, the data flow information 51 is acquired.

In Step S5A, the inter-device adjustment coefficient information 52 is acquired.

In Step S53, the measurement of the execution time starts at start of the cycle process of the software.

In Step S5B, the data received in the cycle is stored together with information of how many cycles.

In Step S5C, from the device assignment information 50 and the data flow information 51, the inter-device adjustment coefficient corresponding to the received data is determined. For example, assume the case where the new software 12 is the software B and a transmission source of the data is the software A. From the device assignment information 50 in FIG. 10 and the data flow information 51 in FIG. 11, since the software A communicates with the software B using CAN, with reference to the corresponding row of the inter-device adjustment coefficient information 52 in FIG. 12, it is seen that the inter-device adjustment coefficient is 1.

In Step S5D, based on the inter-device adjustment coefficient determined in Step S5C, among the past received data stored in Step S5B, the past data selected based on the inter-device adjustment coefficient is used as an input in the current control cycle process to execute the process.

In Step S54, immediately before the data output process in the cycle process of the software, the measurement of the execution time is terminated and the execution time is stored.

In Step S55, when the measured execution time is shorter than the estimated execution time 40, busy wait is executed by the difference time.

In Step S56, the data output process is executed.

In Step S57, whether an execution result of the software satisfies a measurement termination condition is determined. When the measurement termination condition is satisfied, the process is terminated, and when the measurement termination condition is not satisfied, the process proceeds to Step S53. The measurement termination condition, for example, can be determined from whether any given time has passed, whether a destination has been arrived by automatic driving when the software relates to automatic driving, and whether an error, such as the automatic driving having been not able to be continued, is issued. Additionally, the plurality of measurement termination conditions may be combined.

In such a procedure, the software execution management unit 5 in the second embodiment executes the new software 12 on the host environment 100.

The above-described processes from Step S5B to S5D will be described in further detail. With reference to FIG. 10 and FIG. 11, for example, software E receives data from the software C executed on the microcomputer A and software D executed on the control device. From FIG. 11 and FIG. 12, data communication between the software C and the software E is executed by Wi-Fi and the inter-device adjustment coefficient is 8. That is, this means that, in execution of the software E at the N-th cycle, the data generated by the software C at the N−8-th cycle is used. Similarly, data communication between the software D and the software E is executed by Ethernet (Eth: registered trademark), and the inter-device adjustment coefficient is 2. This means that, in execution of the software E at the N-th cycle, the data generated by the software D at the N−2-th cycle is used.

Thus, in the above-described example, the data used for the N-th cycle of the software E becomes data generated by the software C at the N−8-th cycle and the data generated by the software D at the N−2 cycle. However, it is considered that due to the performance difference between the host environment 100 and the target environment 110, when the same software is executed on the host environment 100, the data used at the N-th cycle of the software E is, for example, the data generated by the software C at the N−2-th cycle and the data generated by the software D at the N−2-th cycle. In this case, since the timing at which the data used to execute the software E is generated differs from that of the target environment 110, the execution result on the host environment 100 differs from the execution result on the target environment 110, and reproducing the target environment 110 with high accuracy in the host environment 100 is impossible.

In contrast to this, since a delay according to the communication method between the devices is inserted by the process flow executed by the software execution management unit 5 in the second embodiment, when the new software 12 is executed on the host environment 100, adjustment so as to be the communication timing when the process is executed on the target environment 110 is possible.

Note that, in this embodiment, while the process of adjusting data receiving side data is executed, the process of adjusting data transmission side data also allows obtaining the similar effect.

As described above, according to the simulation method in the second embodiment, by using the device assignment information 50, the data flow information 51, and the inter-device adjustment coefficient information 52, the transmission and reception timings of the data when the process is executed between pieces of software are adjusted. Thus, when the new software 12 is executed on the host environment 100, the adjustment can be performed so as to be the communication timing when the process is executed on the target environment 110. Therefore, the generation timing of the data when the software is executed on the target environment 110 can be accurately reproduced on the host environment 100.

### Third Embodiment

A simulation method in the third embodiment of the present invention will be described.

The third embodiment differs from the first embodiment in that estimation of an execution order when a software group including the new software 12 is executed on the target environment 110 and comparison and validation of the execution order with an execution order when the software group is executed on the host environment 100 are further included. Thus, presence of possibility that simulation executed by an event caused by the host environment 100 was not able to be correctly executed can be sensed. Note that the identical reference numeral is given to the configuration similar to the first embodiment and the description will be omitted.

### <Outline of Simulation Method>

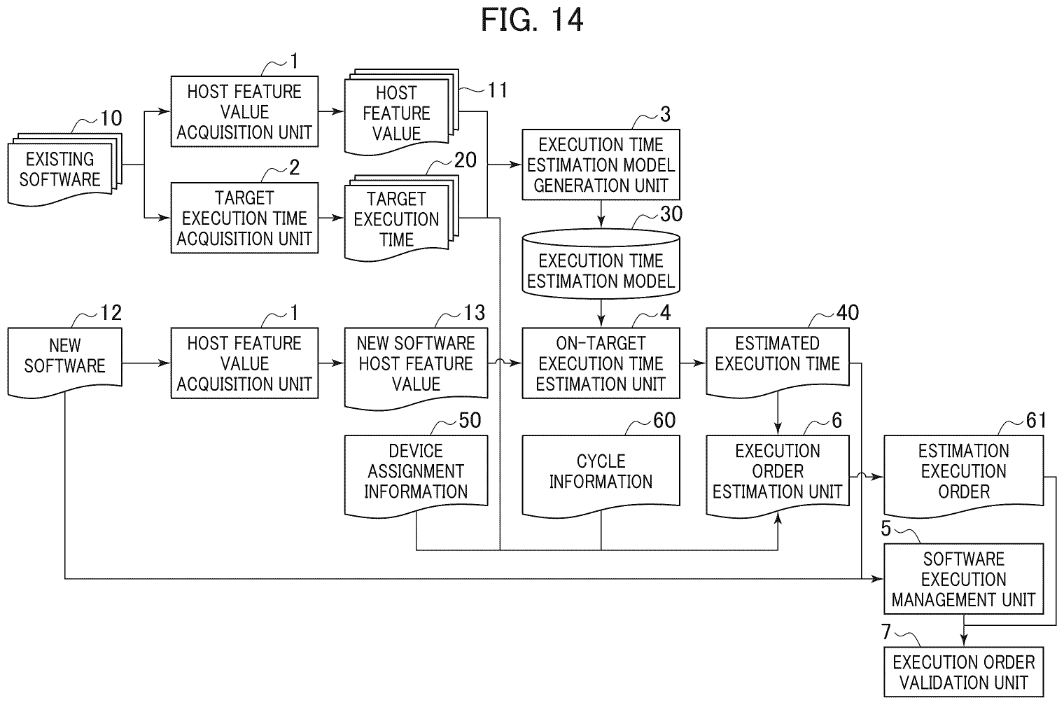

FIG. 14 is a diagram illustrating an outline of the simulation method in the third embodiment.

In the simulation method according to the embodiment, in addition to the first embodiment, processes by an execution order estimation unit 6 and an execution order validation unit 7 are further executed. The execution order estimation unit 6 and the execution order validation unit 7 are, for example, functional units mounted on the host environment 100.

To the execution order estimation unit 6, the target execution time 20, the device assignment information 50, and cycle information 60 are input, and an estimation execution order 61 is output. The execution order validation unit 7 receives the execution result and the estimation execution order 61 when the software is executed on the host environment 100 and verifies whether the software was correctly executed on the host environment 100.

### <Cycle Information>

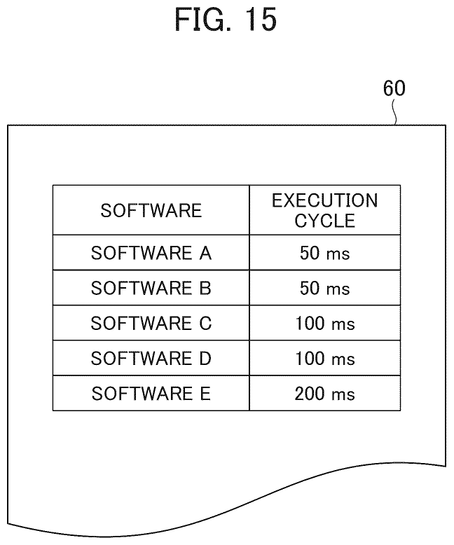

FIG. 15 is a diagram illustrating an example of the cycle information 60 in the present invention. The cycle information 60 is, for example, stored in the host environment 100.

The cycle information 60 indicates information on an execution cycle of each software. For example, the software A is executed once per 50 ms.

### <Execution Order Estimation Unit>

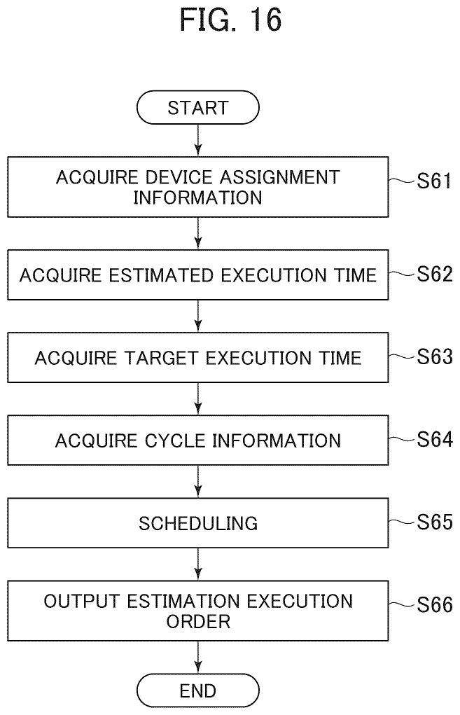

FIG. 16 is a diagram illustrating an outline of a process flow by the execution order estimation unit 6 in the present invention.

The execution order estimation unit 6 acquires the device assignment information 50 in Step S61.

In Step S62, the estimated execution time 40 is acquired from the on-target execution time estimation unit 4.

In Step S63, the target execution time 20 is acquired from the target execution time acquisition unit 2.

In Step S64, the cycle information 60 is acquired.

In Step S65, scheduling is executed to estimate the execution order of the software group. As a scheduling algorithm, the known algorithm, such as a round robin method and rate-monotonic scheduling method, is used.

In Step S66, the execution order estimated in Step S65 is output as the estimation execution order 61.

In such a procedure, the execution order estimation unit 6 acquires/outputs the estimation execution order 61.

### <Execution Order Validation Unit>

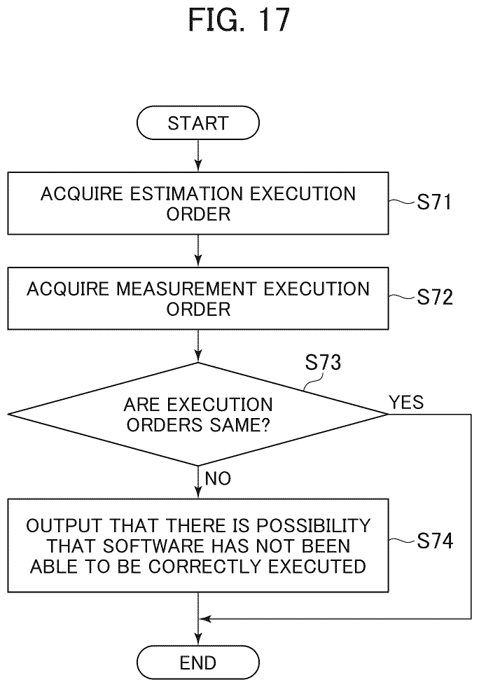

FIG. 17 is a diagram illustrating an outline of a process flow executed by the execution order validation unit 7 in the present invention. The execution order validation unit 7 acquires the estimation execution order 61 from the execution order estimation unit 6 in Step S71.

In Step S72, the measurement execution order measured when the software group is executed on the host environment 100 is acquired.

In Step S73, whether the estimation execution order 61 and the measurement execution order are the same is determined. When the estimation execution order 61 and the measurement execution order are the same, the process is terminated, and when the estimation execution order 61 and the measurement execution order are not the same, the process proceeds to Step S74.

In Step S74, a fact that there is a possibility that the software was not able to be correctly executed is output. For example, in the host environment 100, since the software other than the software group executed this time interrupts, there is a possibility that the execution order changes. In such a procedure, the execution order validation unit 7 evaluates the execution order.

As described above, according to the simulation method in the third embodiment, the execution order of the software group when the software group is executed on the target environment 110 is estimated and the execution order is compared with the execution order when the software group is actually executed on the host environment 100. In execution on the host environment 100, since the execution time on the target environment 110 is reproduced, when an interrupt by another software or the like is absent, the execution order is the same. Therefore, comparison between the estimated execution order and the executed execution order allows determining whether the execution result is by only the assumed software group.

### Fourth Embodiment

A simulation method in the fourth embodiment of the present invention will be described.

The fourth embodiment is an embodiment that executes an additional process to the third embodiment, and differs from the third embodiment in that processes by a specification evaluation unit 8 and a function assignment unit 9 are further executed. The specification evaluation unit 8 and the function assignment unit 9 are, for example, functional units mounted on the host environment 100. The specification evaluation unit 8 determines whether the execution of the software group satisfies the specification from the estimated execution time 40, the device assignment information 50, the cycle information 60, a software specification 80, and the estimation execution order 61. When the execution of the software group does not satisfy the specification, the function assignment unit 9 assigns the software. Note that the identical reference numeral is given to the configuration similar to the third embodiment and the description will be omitted.

### <Outline of Simulation Method>

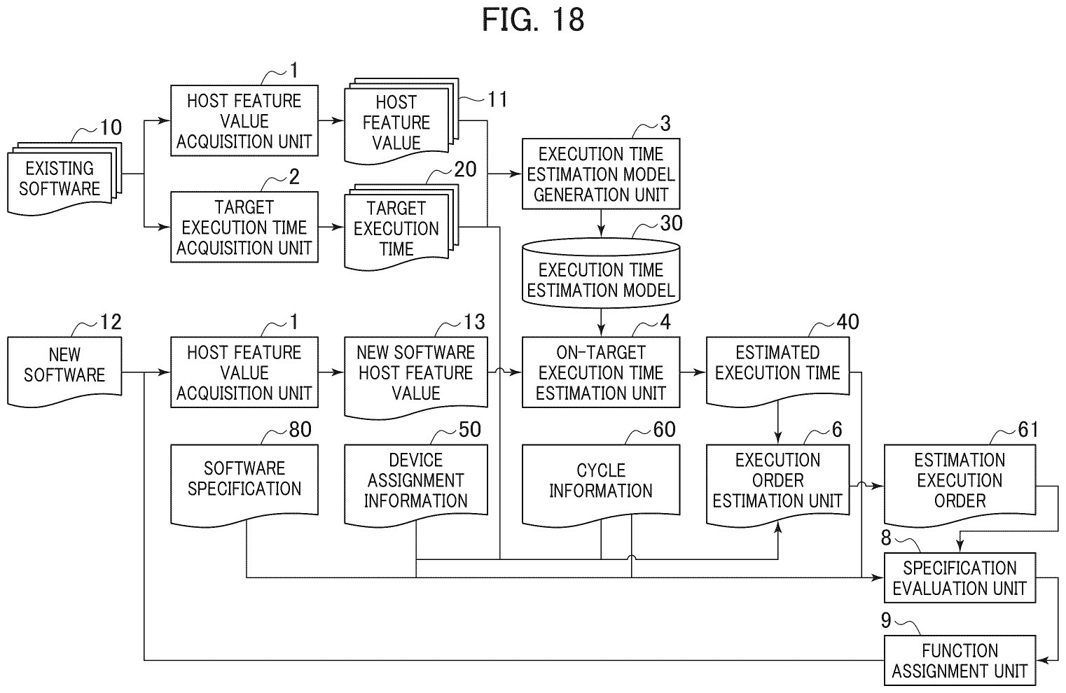

FIG. 18 is a diagram illustrating an outline of the simulation method in the fourth embodiment.

To the specification evaluation unit 8, for example, the estimated execution time 40, the device assignment information 50, the cycle information 60, the software specification 80, and the estimation execution order 61 are input. The software specification 80, for example, may be mounted on the host environment 100 or may be given by manually inputting from outside.

### <Software Specification>

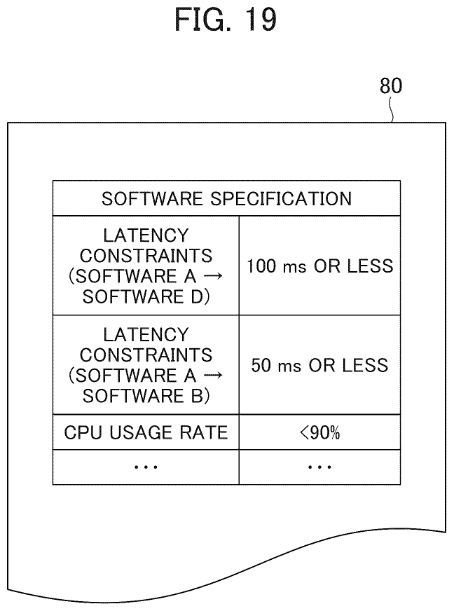

FIG. 19 is a diagram illustrating an example of the software specification 80 in the present invention.

For example, a specification that a time taken from starting execution of the software A until completing execution of the software D is 100 ms or less and a specification that a CPU load is less than 90% are described.

### <Specification Evaluation Unit>

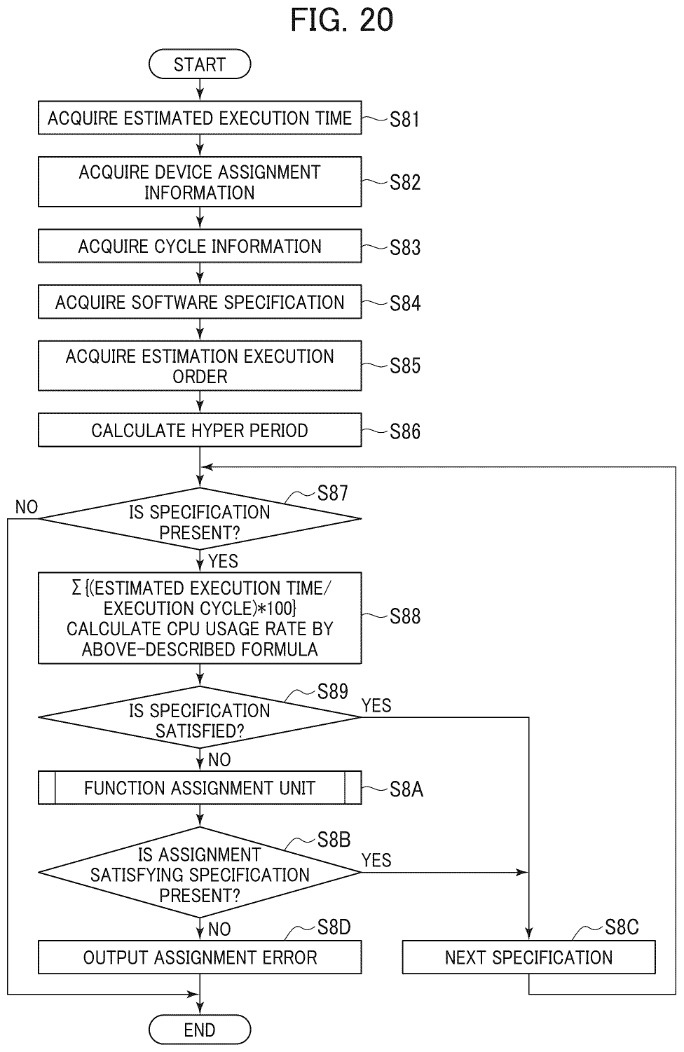

FIG. 20 is a diagram illustrating an outline of a process flow by the specification evaluation unit 8 in the present invention.

The specification evaluation unit 8 acquires the estimated execution time 40 from the on-target execution time estimation unit 4 in Step S81.

In Step S82, the device assignment information 50 is acquired.

In Step S83, the cycle information 60 is acquired.

In Step S84, the software specification 80 is acquired.

In Step S85, the estimation execution order 61 is acquired from the execution order estimation unit 6.

The specification evaluation unit 8 calculates hyper period in Step S86. The hyper period means the least common multiple of the execution cycle of the software operated in each of the devices. The software operated in each of the devices is found based on the device assignment information 50 (see FIG. 10). Additionally, based on the cycle information 60 (see FIG. 15), the execution cycle of the software operated in each of the devices is found. That is, for example, based on FIG. 10, the software operated on the microcomputer A is the software A and the software C. Based on FIG. 15, since the software A is at a 50 ms cycle and the software C is a 100 ms cycle, 100 ms as the least common multiple becomes the hyper period.

In Step S87, whether the specification regarding the execution of the software is present is determined. When the specification is present, the process proceeds to Step S88, and when the specification is not present, the process is terminated.

In Step S88, a CPU usage rate is calculated. The CPU usage rate can be calculated by Σ{(estimated execution time/execution cycle)*100}.

In Step S89, whether the execution of the software satisfies the specification is determined. When the specification is satisfied, the process proceeds to Step S8C, and when the specification is not satisfied, the process proceeds to Step S8A. For example, when the CPU usage rate of FIG. 19 is determined, it is only necessary to determined that the CPU usage rate obtained in Step S88 is less than 90%. When latency constraints are determined, since the time until the execution is completed can be calculated from the estimation execution order 61 and the estimated execution time 40, it is only necessary to determine whether the time satisfies the specification.

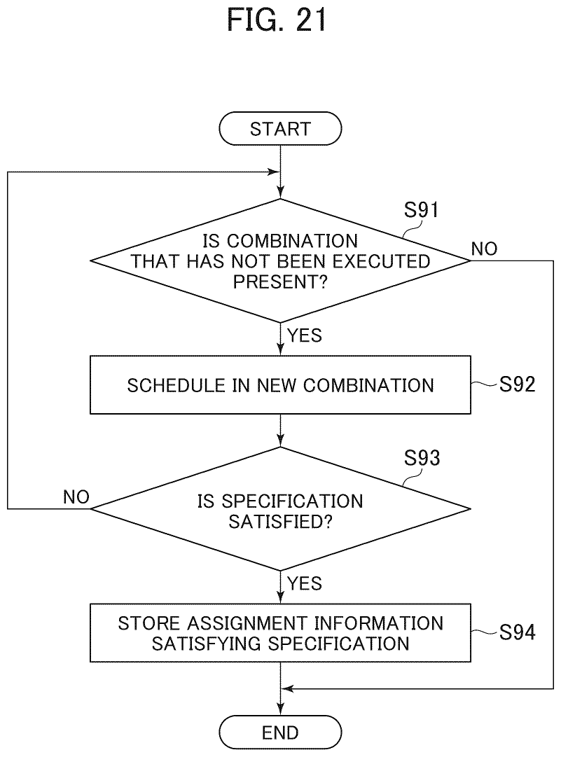

When it is determined that the specification is not satisfied in Step S89, the function is assigned in Step S8A and the function assignment unit 9. The assignment of the function will be described later using FIG. 21.

As a result of assigning the function in Step S8B, whether the assignment satisfying the specification is present is determined. When the assignment satisfying the specification is present, the process proceeds to Step S8C, and when the assignment satisfying the specification is not present, the process proceeds to Step S8D.

The process moves to Step S8C and the next specification, and returns to Step S87 to continue the process.

In Step S8D, an assignment error is output. Depending on the assignment of the function, since the specification cannot be satisfied, for example, redevelopment of the software and review of the device to be specified are necessary.

In such a procedure, the specification evaluation unit 8 determines whether the specification is satisfied. When the specification is not satisfied, the function is attempted to be assigned. When the specification is not satisfied even when the function is assigned, the assignment error is output.

### <Function Assignment Unit>

FIG. 21 is a diagram illustrating an outline of a process flow executed by the function assignment unit 9 in the present invention.

The function assignment unit 9 determines whether a combination that is not executed is present in Step S91. When the combination that is not executed is present, the process proceeds to Step S92, and when the combination that has not been executed is present, the process is terminated. Note that the combination in this embodiment is a combination of the software and the device described in the device assignment information 50. That is, the combination is the combination of the software and the device executing the software shown in FIG. 10.

In Step S92, scheduling in a new combination, that is, an order of executing the software is set.

In Step S93, whether the execution of the software by the new combination satisfies the specification is determined. When the specification is satisfied, the process proceeds to Step S94, and when the specification is not satisfied, the process returns to Step S91.

In Step S94, the assignment information satisfying the specification is stored.

In such a procedure, the function assignment unit 9 determines whether the function assignment satisfying the specification is present.

According to the simulation method in the fourth embodiment, whether the execution of the software group including the new software 12 satisfies the specification is determined. Even when the specification is not satisfied, whether the specification can be satisfied by the assignment of the function can be determined.

While the first embodiment to the fourth embodiment have been described, simulation may be executed by the combination of the two or more embodiments among them.

### <Summary of Operational Advantage of Respective Embodiments>

In the simulation method according to the first embodiment, by inputting the new software host feature value 13 when the new software 12 is executed on the host environment 100 to the execution time estimation model 30, without porting the new software 12 to the target environment 110, the worst execution time when the new software 12 is executed on the target environment 110 can be estimated. Then, based on the estimated execution time 40, executing the new software 12 on the host environment 100 allows validation by simulation on the target environment 110 with high accuracy. Therefore, the software developed on the host environment 100 can be seamlessly ported to the target environment 110.

In the simulation method according to the second embodiment, when the new software 12 is executed on the host environment 100, by adjustment so as to be the communication timing at execution on the target environment 110 based on the inter-device adjustment coefficient, the generation timing of the data when the software is executed can be reproduced.

In the simulation method according to the third embodiment, in execution of the software group including the new software 12 on the host environment 100, since the execution time is reproduced on the target environment 110, when an interrupt by another software or the like is absent, the execution order is the same. Therefore, by comparison between the estimated execution order and the executed execution order, whether the execution result on the host environment 100 is affected by one other than the executed software can be determined.

According to the simulation method in the fourth embodiment, whether the execution of the software group including the new software 12 satisfies the specification is determined. Even when the specification is not satisfied, whether the specification can be satisfied by the assignment of the function can be determined.

According to the embodiments of the present invention described above, the following operational advantages are provided.

(1) The simulation method according to one embodiment of the present invention includes: extracting a first host feature value obtained by executing first software on a host environment; executing the first software on a target environment to calculate a target execution time taken to execute the first software on the target environment; calculating a performance difference between the host environment and the target environment based on the first host feature value and the target execution time; extracting a second host feature value obtained by executing second software on the host environment; and estimating a time taken to execute the second software on the target environment based on the second host feature value and the performance difference.

This configuration reproduces the target environment with high accuracy on the host environment developing the software. That is, the target environment is simulated on the host environment. Therefore, even when the software is not actually ported to the target environment, whether the software can be normally executed on the target environment can be verified, to thereby improve development efficiency of the software.

(2) An execution time when the second software is executed on the host environment is adjusted based on the estimated time. This allows compensating the performance difference between the host environment and the target environment, and the target environment can be simulated with further high accuracy.

(3) An inter-device adjustment coefficient regarding transmission and reception timings of data on the target environment is acquired, and the transmission and reception timings of the data are adjusted based on the inter-device adjustment coefficient when the second software is executed on the host environment. Thus, when the new software 12 is executed on the host environment, the adjustment can be performed so as to be the communication timing when the process is executed on the target environment based on the inter-device adjustment coefficient. Therefore, the generation timing of the data when the software is executed can be synchronized.

(4) An execution order of the first software and the second software on the target environment is estimated based on the target execution time, an execution time on the target environment estimated regarding the second software, and respective cycle information of the first software and the second software. Accordingly, the execution order when the software group including the new software is executed on the target environment is estimated, and the execution result when the software group is executed in accordance with the execution order can be predicted.

(5) The estimated execution order and an execution order when the first software and the second software are executed on the host environment are compared with each other, thereby to verify whether the second software has been able to be correctly executed on the host environment. This allows evaluating, for example, a case where the new software in the estimated execution order cannot be correctly executed, such as generation of an interrupt process on the host environment by another software, for example, reset of the execution order is possible.

(6) A plurality of devices configured to execute the first software and the second software are present, the execution of the first software and the second software in the estimated execution order is compared with a predetermined specification, and when the execution of the software in the execution order does not satisfy the specification, a device that executes at least one of the first software or the second software is changed. As a result, whether or not the execution of the software group including the new software 12 satisfies the specification is determined. Even when the execution is not satisfied, whether the specification can be satisfied by res-assigning the function can be determined.

(7) The first host feature value and the second host feature value include at least an execution time of the software. This allows calculating the performance difference between the host environment and the target environment using the execution time of the software, and the target environment can be reproduced with further high accuracy on the host environment developing the software.

It should be noted that the present invention is not limited to the examples described above, and includes various modification examples. For example, the above-described embodiments have been described in detail in order to facilitate the understanding of the present invention, and the present invention is not necessarily limited to those including all of the described configurations. In addition, part of the configuration of one embodiment can be replaced with the configurations of other embodiments. Further, the configuration of the one embodiment can also be added with the configurations of other embodiments. In addition, part of the configuration of each of the embodiments can be subjected to addition, deletion, and replacement with respect to other configurations.

### LIST OF REFERENCE SIGNS

1: Host feature value acquisition unit, 2: Target execution time acquisition unit, 3: Execution time estimation model generation unit, 4: On-target execution time estimation unit, 5: Software execution management unit, 6: Execution order estimation unit, 7: Execution order validation unit, 8: Specification evaluation unit, 9: Function assignment unit, 10: Existing software (first software), 11: Host feature value (first feature value), 12: New software (second software), 13: New software host feature value (second feature value), 20: Target execution time, 30: Execution time estimation model, 40: Estimated execution time, 50: Device assignment information, 51: Data flow information, 52: Inter-device adjustment coefficient information, 60: Cycle information, 61: Estimation execution order, 80: Software specification, 100: Host environment, 110: Target environment

1. A simulation method comprising:
extracting a first host feature value obtained by executing first software on a host environment;
executing the first software on a target environment to calculate a target execution time taken to execute the first software on the target environment;
calculating a performance difference between the host environment and the target environment based on the first host feature value and the target execution time;
extracting a second host feature value obtained by executing second software on the host environment; and
estimating a time taken to execute the second software on the target environment based on the second host feature value and the performance difference.

2. The simulation method according to claim 1, comprising
adjusting an execution time when the second software is executed on the host environment based on the estimated time.

3. The simulation method according to claim 1, comprising:
acquiring an inter-device adjustment coefficient regarding transmission and reception timings of data on the target environment; and
adjusting the transmission and reception timings of the data based on the inter-device adjustment coefficient when the second software is executed on the host environment.

4. The simulation method according to claim 1, comprising
estimating an execution order of the first software and the second software on the target environment based on the target execution time, an execution time on the target environment estimated regarding the second software, and respective cycle information of the first software and the second software.

5. The simulation method according to claim 4, comprising
comparing the estimated execution order with an execution order when the first software and the second software are executed on the host environment, to verify whether the second software has been able to be correctly executed on the host environment.

6. The simulation method according to claim 4, wherein
a plurality of devices configured to execute the first software and the second software are present, and
execution of the first software and the second software in the estimated execution order is compared with a predetermined specification, and when the execution of the software in the execution order does not satisfy the specification, a device that executes at least one of the first software or the second software is changed

7. The simulation method according to claim 1, wherein
the first host feature value and the second host feature value include at least an execution time of the software.
